(19) United States
(12) Patent Application Publication
(10) Pub. No.: US 2009/0328037 A1
(43) Pub. Date: Dec. 31, 2009

(54) 3D GRAPHICS ACCELERATION IN REMOTE MULTI-USER ENVIRONMENT

(76) Inventor: Gabriele Sartori, Fremont, CA (US)

Correspondence Address: SCHWEGMAN, LUNDBERG & WOESSNER, P.A., P.O. BOX 2938, MINNEAPOLIS, MN, 55402, US

(21) Appl. No.: 12/395,072

(22) Filed: Feb. 27, 2009

Related U.S. Application Data
(60) Provisional application No. 61/031,991, filed on Feb. 27, 2008.

(51) Int. Cl. G06F 9/455; G06F 13/14

(52) U.S. Cl. 718/1; 345/519

(57) ABSTRACT

Systems and methods for providing graphics acceleration to one or more terminal systems are disclosed. In one embodiment, a virtual machine session is created and one or more cores of a graphics accelerator with a plurality of cores is assigned to a virtual machine session in order to render a virtual desktop for display at a terminal system.

### CROSS-REFERENCE TO RELATED APPLICATIONS

This application claims the benefit of U.S. Provisional Patent Application Ser. No. 61/031,991 filed Feb. 27, 2008 (“3D GRAPHICS ACCELERATION IN REMOTE MULTI-USER ENVIRONMENT”), which application is incorporated herein by reference in its entirety.

### FIELD

The present application relates to the field of computer graphics. In particular, but not by way of limitation, the present application discloses techniques for transmitting display information in a multi-user environment.

### BACKGROUND

Centralized computer systems with multiple computer terminals for accessing the centralized computer systems were once the dominant computer architecture. Mainframe computer systems were shared by multiple computer users in a manner wherein each individual computer user had access to a separate computer terminal system coupled to the mainframe computer system. Although personal computers have become the dominant form of computing, there has been a resurgence of the centralized computer system with multiple terminals form of computing.

Furthermore, computer graphics have increased in both resolution and color depth over the years. While computer users once accepted text-only display systems, modem computers employ high resolution graphical display capabilities.

### BRIEF DESCRIPTION OF THE DRAWINGS

In the drawings, which are not necessarily drawn to scale, like numerals describe the same or similar components. The drawings illustrate generally, by way of example and not by way of limitation, various example embodiments.

FIG. 1A illustrates a block diagram of a computer network system with a server system and a set of thin-client network nodes that use the example embodiments.

FIG. 1B illustrates a high-level block diagram of one embodiment of a thin-client terminal system coupled to a thin-client server computer system.

FIG. 2 illustrates a schematic diagram of a multi-core graphics processing unit, in accordance with an example embodiment, including a plurality of cores provided on a single silicon die.

FIG. 3 illustrates a block diagram of a graphics processing unit, in accordance with an example embodiment, including a single graphics accelerator core associated with a display.

FIG. 4 illustrates a block diagram of a graphics processing unit, in accordance with an example embodiment, including a plurality of graphics accelerator cores, wherein each core is associated with a display.

FIG. 5A illustrates a schematic diagram of a machine in the form of a server system.

FIG. 5B illustrates a schematic diagram of a machine in the form of a server system

FIG. 5C illustrates a schematic diagram of a machine in the form of a server system

FIG. 6 illustrates a method, in accordance with an example embodiment, for rendering graphics.

FIG. 7 illustrates a diagrammatic representation of machine in the example form of a computer system within which a set of instructions, for causing the machine to perform any one or more of the methodologies discussed herein, may be executed.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are disclosed by way of example with reference to a thin-client system, the teachings can be used in any type of digital video display system including personal computer systems, High-Definition Televisions (HDTVs), and mobile computer systems. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

Modem personal computer systems are so powerful that their computing resources generally sit idle for the vast majority of the time such that valuable computing resources are being used very inefficiently. Many of these computers have graphics chips with three-dimensional (3D) graphics capabilities. These graphics chips maintain both 3D and 2D representations of a screen. Example uses include high-end drawing functionality such as computer-aided design (CAD) and consumer products such as video games. However, much of the computing potential of these graphics chips are not fully exploited either.

Terminal based computer systems allow for more efficient use of computing resources and reduced maintenance costs. Terminal-based computer systems allow multiple users at terminals to share a single computer system and the software installed on that computer system. These terminals may be high-resolution terminals sharing a computer system as discussed below. In this manner, a high-resolution terminal is capable of delivering the functionality of a personal computer system without the cost and the maintenance requirements of a personal computer.

A category of these modem terminal systems is called “thin-client” systems. A thin-client is a terminal machine that has less than the full capabilities of a traditional computer system. For example, a thin-client terminal system may have an audio output system, a high-resolution video display, a video decoder, a screen buffer, a video adapter, systems for supporting input, a network interface, and a control system. Although the techniques set forth this document will mainly be disclosed with reference to thin-client systems, the techniques described herein are applicable to any other terminal system, even if the terminal is a computer system itself. Furthermore, the techniques set forth in this document will also be applicable in other area of the IT industry as well.

Terminal based computer systems may also provide increased security since users of some computer terminals may not easily introduce computer viruses by downloading or installing new software. Computer terminals may include high-resolution graphics capabilities that personal computer users have become accustomed to.

Terminal based computer systems may be defined to include remote computing systems, thin-client systems, or any other computer based system where processing is done at a location other than the location of the terminal, thin-client, computer, or other machine. The embodiments disclosed herein may apply to any of these terminal based computer systems.

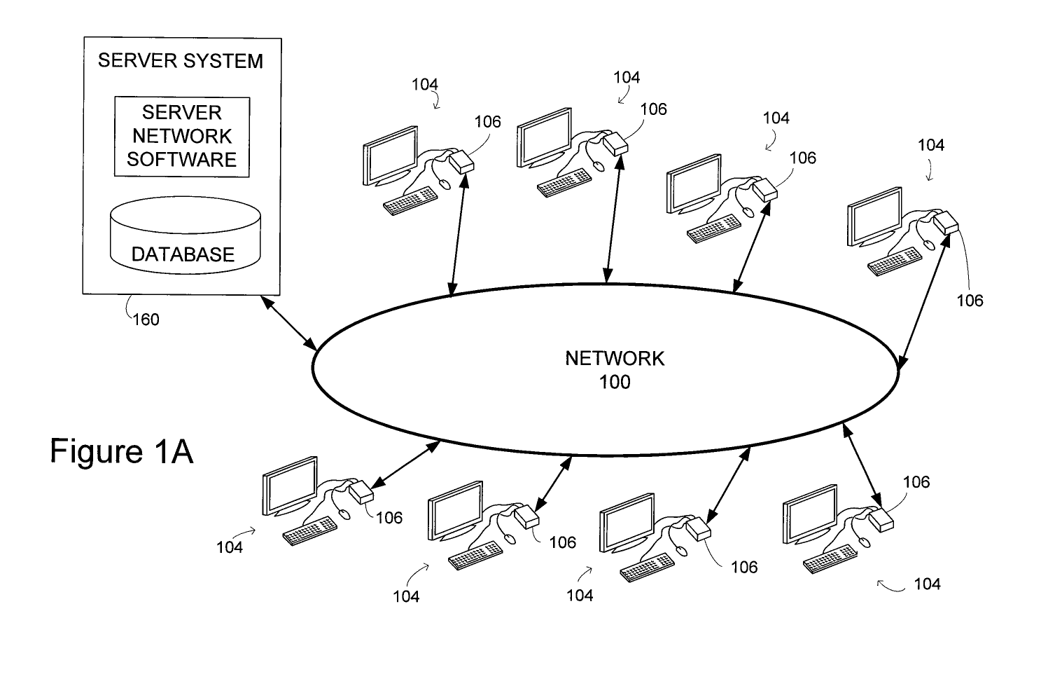

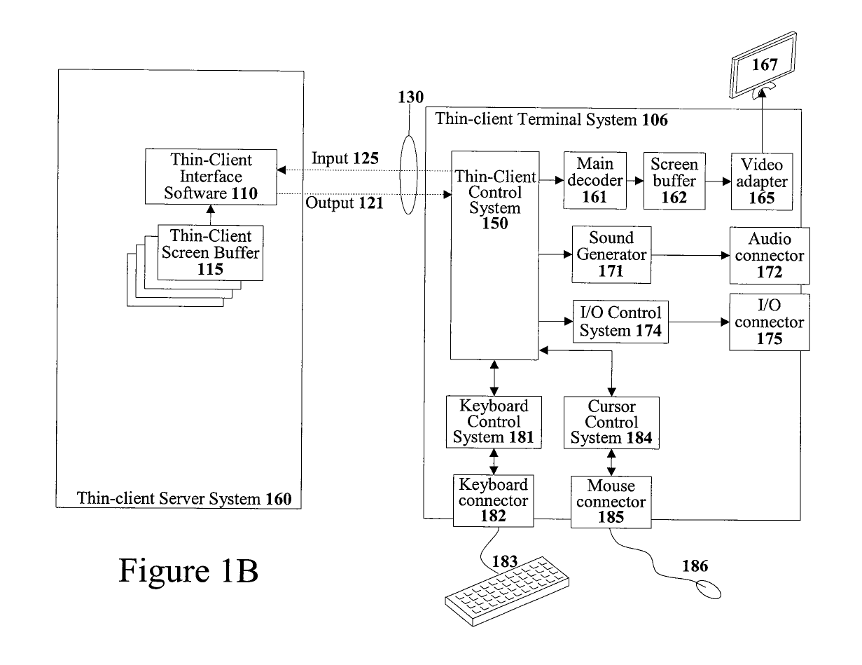

FIG. 1A illustrates an example deployment of a terminal based computer system where a server provides computer resources to multiple clients; more specifically, FIG. 1A shows a server-based thin-client system in which a single thin-client server computer system 160 provides computer processing resources to many thin-client terminal systems 106. In the embodiment of FIG. 1A, each of the individual thin-client terminal systems 106 is coupled to the thin-client server computer system 160 using local area network 130 as a bidirectional communication channel. The thin-client systems 104 illustrated in FIG. 1A consists of a display, a keyboard, a cursor control device, and the network-connected thin-client device 106.

In some embodiments, the thin-client systems 104 may have little computing resources of their own. For example, in one embodiment, the thin-client device 106 or network terminal may or may not have a CPU. Since the thin-client device 106 in this embodiment may not be a full-fledged computer system, the thin-client device 106 provides the user with additional computing resources by accessing the server computer system 160 across a communication channel such as a network 100.

In an example method of providing access to the computing resources on the server computer system 160 is to have the thin-client devices 106 act as simple terminal devices. Each thin-client device 106 may transmit its keystrokes and cursor control device movements (e.g., manipulations by a device user) across the network 100 as input to the server computer system 160 and the server computer system 160 transmits video display information (e.g., a bitmap) across the network 100 as output to the thin-client device 106. However, not all processing must occur at the server computer system. For example, in another example method of providing access to the computing resources on the server computer system 160, the thin-client devices 106 are able to perform some processing and transmit certain data across the network 100 as input to the server computer system 160. The server system may then transmit data including video display information across the network 100 as output to the thin-client device 106. In some embodiments, the server system 160 may use various compression techniques in sending the display representations to the thin-client 106.

The server system 160 may provide graphics processing for each terminal or thin-client system 104 connected or logged on to it. In one embodiment, the thin-client system 104 may show a frame buffer on its screen that is represented in the server 160 and sent to the thin-client device 106. A frame buffer is a memory or memory array that contains a complete frame of data used in displaying video.

FIG. 1B illustrates a high-level block diagram of one embodiment of a thin-client server computer system 160 coupled to one (of possibly many) thin-client terminal system 106. The thin-client server computer system 160 and thin-client terminal system 106 are coupled to a with a bi-directional digital communications channel 130 that may be a serial data connection, an Ethernet connection, or any other suitable bi-directional digital communication means.

The goal of thin-client terminal system 106 is to provide most or all of the standard input and output features of a personal computer system to the user of the thin-client terminal system 106. However, this goal is to be achieved without providing the full computing resources or software of a personal computer system within thin-client terminal system 106 since those features will be provided by the thin-client server system 160 that will interact with the thin-client terminal system 106.

Referring back to FIG. 1B, the thin-client terminal system 106 provides both visual and auditory output using a high-resolution video display system and an audio output system. The high-resolution video display system consists of a video decoder 161, a screen buffer 162, and a video adapter 165. The video decoder decodes digital video information and places that digital video information into screen buffer 162. Screen buffer 162 contains the contents of a bit-mapped display. Video adapter 165 reads the video display information out of screen buffer 162 and generates a video display signal to drive display system 167. The screen buffer 162 is filled with video display information provided by thin-client control system 150 using video information sent as output 121 by the thin-client server system 160 across bi-directional communications channel 130. Similarly, the audio system consists of a sound generator 171 coupled to an audio connector 172 for creating a sound signal. The sound generator 171 is supplied with audio information thin-client control system 150 using audio information sent as output 121 by the thin-client server system 160 across bi-directional communications channel 130.

From an input perspective, thin-client terminal system 106 allows for both alpha-numeric input and cursor control input from a terminal system user to be supplied to the thin-client computer system 160. The alpha-numeric input is provided by a keyboard 183 coupled to a keyboard connector 182 that supplies signals to a keyboard control system 181. Thin-client control system 150 encodes keyboard input from keyboard control system 181 and sends that keyboard input as input 125 to the thin-client server system 160. Similarly, the thin-client control system 150 encodes cursor control input from cursor control system 184 and sends that cursor control input as input 125 to the thin-client server system 160. The cursor control input is received through a mouse connector 185 from a computer mouse 186 or any other suitable cursor control device such as a trackball, trackpad, etc.

The thin-client terminal system 106 may include other input, output, or combined input/output systems in order to provide additional functionality to the user of the thin-client terminal system 106. For example, the thin-client terminal system 106 illustrated in FIG. 1B includes input/output control system 174 coupled to input/output connector 175. Input/output control system 174 may be a Universal Serial Bus (USB) controller and input/output connector 175 may be a USB connector in order to provide Universal Serial Bus (USB) capabilities to the user of thin-client terminal system 106.

Thin-client server computer system 160 is equipped with multi-tasking software for interacting with multiple thin-client systems. As illustrated in FIG. 1B, thin-client interface software 110 in thin-client server system 160 supports the thin-client terminal system 106 as well as any other thin-client terminal systems coupled to thin-client server system 160. Each thin-client terminal system 106 will have its own screen buffer in the thin-client server system 160 such as thin-client terminal screen buffer 115.

The server 160 may run virtualization software or terminal server software to allow multiple users to share the server 160 as if they are running an independent machine. A session may be created each time a terminal or thin-client 106 connects to the system server 160 and either the virtualization software or the terminal server software creates a “virtual” graphics card for each session. The server system 160 performs various processing tasks for the terminal or thin-client 160 and the virtual graphics card for the session renders display information to a frame buffer. When the frame buffer is updated, the server software sends information about the changed pixels to the thin-client terminal 106. The thin-client system 104 may then represent the changes on its screen. In one embodiment, each session has its own an associated two-dimensional (2D) frame buffer in memory.

In system proposed by the present disclosure, a graphics processing unit (GPU), or other graphics accelerator, with a plurality of cores is implemented in the server computer system 160 and one or more cores are assigned to a session associated with a thin-client. In this manner, the assigned cores provide graphics processing for the user sessions in the server computer system 160 associated with thin-client systems 104.

In an example embodiment, each session running on a server is assigned a fully dedicated graphics core. For example, multiple thin-client terminal devices 106 may be connected via a network 100 to a server system 160 that includes multiple 3D graphics cores. One or more of these graphics cores are assigned to each session which in turn serves a thin-client terminal device 106. The network 100 may be a LAN, WAN, or any other network.

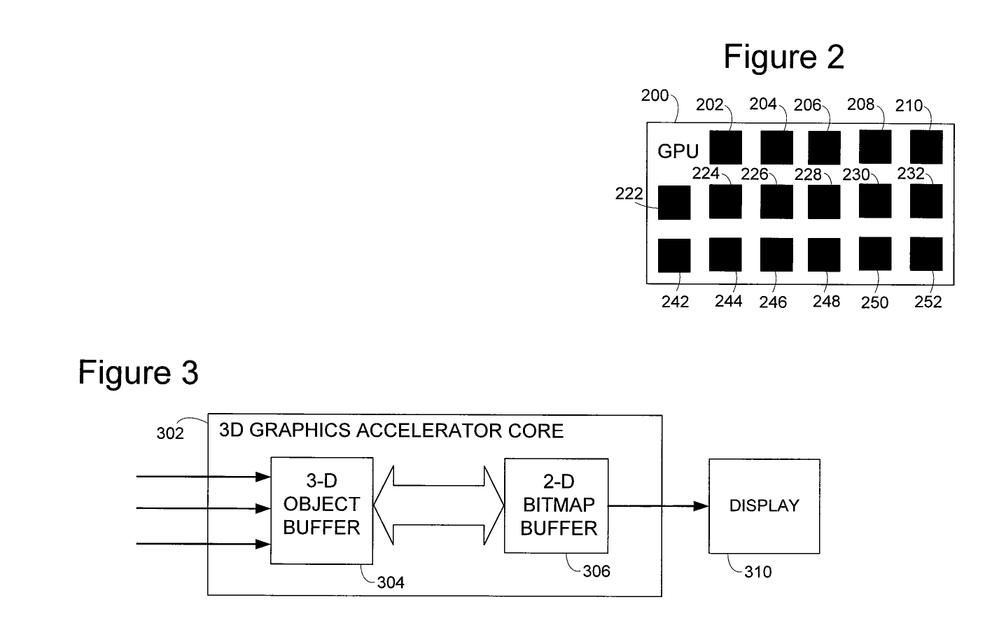

FIG. 2 illustrates a conceptual diagram of a multi-core graphics processing unit 200. In some embodiments, a plurality of 3D graphics accelerator cores 202-252 (or graphics cores) may be provided on the same silicon die or chip. Providing multiple graphics cores on the same die may be more economical than providing discrete solutions based on individual graphics cores. For example, the graphics accelerator cores 202-252 may be provided in a graphics card or integrated within components of a motherboard. In an example embodiment, a single graphics accelerator core 202 of a number of cores 202-252 may be associated with a remote display (e.g., a remote display connected to a thin-client terminal device 106).

In an example embodiment as shown in FIG. 3, one of the many graphics accelerator cores 302 is assigned to a thin-client session. The 3D models from a 3D object buffer 304 may be rendered by a graphics accelerator core into a 2D buffer (e.g., a 2D bitmap buffer 306) representing a screen to be displayed. The contents of the 2D buffer 306 may then be displayed locally or communicated to a thin-client via a network to a remote display 310.

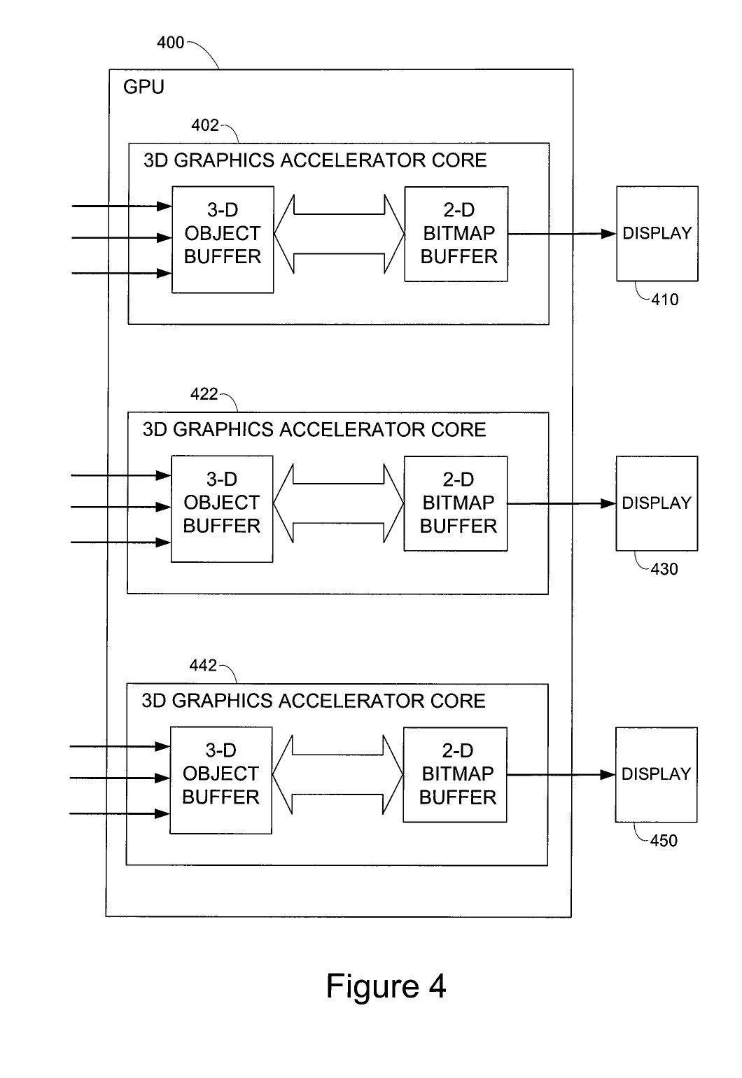

FIG. 4 illustrates a block diagram of a graphics device, in accordance with an example embodiment, including a graphics processing unit 400 with multiple graphics accelerator cores 402, 422, and 442, wherein each graphics accelerator core is associated with a display 410, 430, and 450. Each graphics accelerator core may render a three-dimensional scene into a two-dimensional buffer as illustrated in FIG. 4. The contents of the two-dimensional buffer may then be transmitted via a network to a remote terminal device or thin-client device which, in turn, is connected to a display device (e.g., a computer monitor). The terminal device may, or may not, include a CPU.

The ability to have multiple 3D graphics accelerator cores in a server system that supports multiple user sessions allows an assignment of individual cores to individual user sessions. In example embodiments, either in a virtual machine environment (e.g., paravirtual or fully virtual) or in a terminal server environment, each session may have one of the available 3D graphics accelerator cores fully assigned and not shared with another session. The 3D graphics accelerator core processes a full 3D rendering into a 2D memory array representing the user's screen. The 2D screen may be transmitted to the client device using TCP/IP or another protocol, giving a full 3D graphics experience to the individual user of the network terminal.

Example implementations may have from 4 to 16 graphics cores in each 3D accelerator device and the 3D accelerator device may be based on a 16 bit PCI-Express. It should be noted that the example embodiments are not limited to this configuration. With semiconductor process technology moving to 35 nm and then to 25 nm and beyond, 3D cores of 64 or even more in each integrated circuit are implementable. Methods such as AMD HyperTransport or Intel QuickPath may also be used.

The virtualization layer or terminal server mechanism in the computer system (e.g., acting as a terminal server serving a plurality of terminal devices) may take only one of these individual graphics cores and assign it to one individual session. Thus, the thin-client associated with that session may be enabled with full 3D graphics acceleration. Using this example method, applications like videogames may be viable in a terminal-server environment, even in embodiments where the thin-client terminal has no native 3D acceleration capabilities at all since the actual 3D rendering is done in the server.

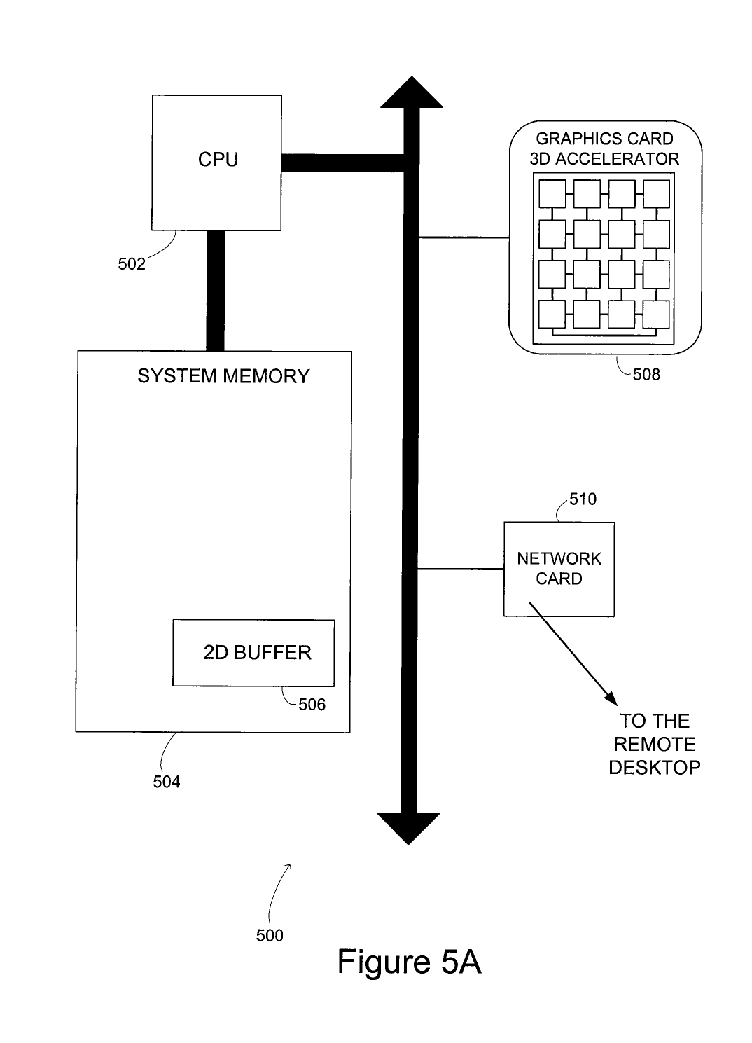

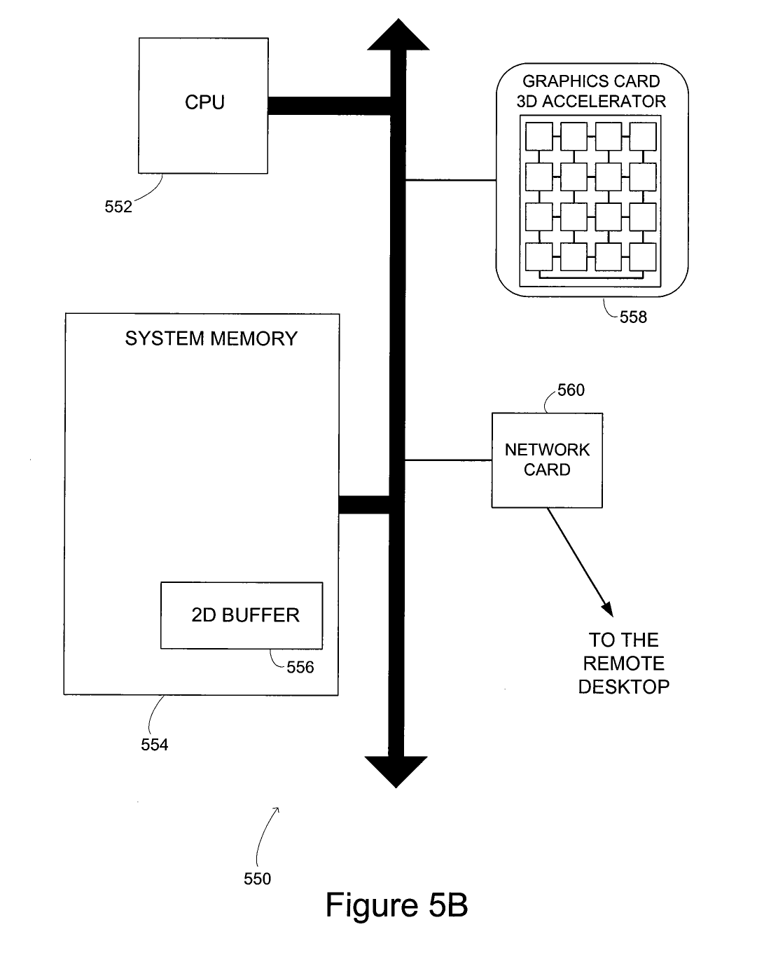

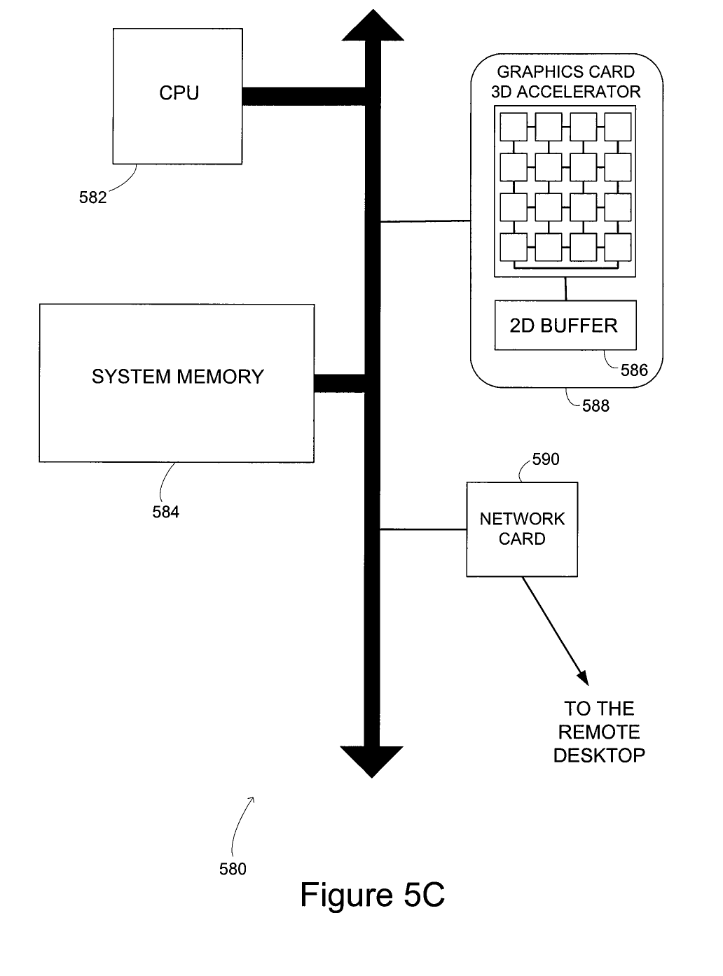

FIGS. 5A and 5B illustrate block diagrams of machines in the form of server systems. In the example embodiments, the server systems 500 and 550 receive inputs from their thin-client terminals through their respective network cards 510 and 560. This input can be of any type. For example, the input may be input from a user, input from a user interface device, application data, diagnostic data, thin-client system data, etc. The server systems 500 and 550 may run various applications and perform various tasks using their respective processors 502 and 552 and memories 504 and 554. In these embodiments, the 3D graphics cores are located on graphics cards 508 and 558. When new user sessions are started with a thin-client terminal, each user session is associated with a virtual graphics card and one of the graphics cores on the graphics cards 508 and 558 is assigned to the user session. In one embodiment, the virtual graphics cards may provide 2D buffers 506 and 556 in the system memories 504 and 554. 3D images are rendered by the graphics cores into the 2D buffer and transmitted to the thin-client.

FIG. 5C also illustrates a block diagram of a machine in the form of a server system. The server system 580 is configured similarly to server system 550. The server system 580 receives inputs from its thin-client terminals through its network card 590, runs various applications and perform various tasks using processor 582 and memory 584, and the 3D graphics cores are located on graphics card 588. However, in the server system 580 illustrated in FIG. 5C, the 2D buffers 586 are located on the graphics card 588. In another embodiment, the 2D buffers may be located within the graphics cores themselves, with each core having its own dedicated 2D buffer.

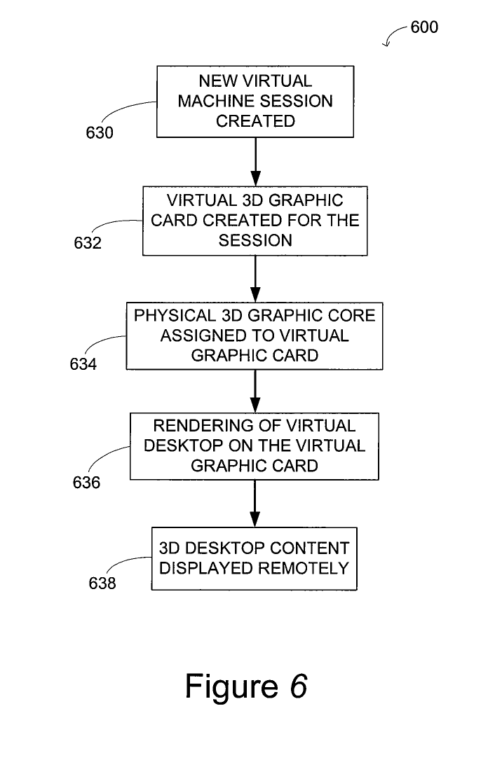

FIG. 6 illustrates a flow diagram of method 600, according to various embodiments, to render graphics to be displayed remotely. The method 600 begins at operation 630 when a new virtual machine session or a new terminal server session is created at the server. This may occur when a thin-client device or a terminal first connects to the server through some communication means, when a user first logs onto the server, or in response to any other request for service. For example, when a thin-client device connects to the server 550 through the server's network card 560 connected to a network or the internet, software on the server (e.g., virtualization software or terminal server software) may create a new session.

At operation 632, a virtual 3D graphics card is created for the user session. Next, at operation 634, an available graphics core is assigned to the virtual 3D graphics card associated with that user session. As discussed above, the graphics core may be located on a graphics card such as graphics cards 508 and 558.

At operation 636, the server software renders the virtual desktop to a 2D buffer (e.g., 2D buffer 556 or 586) using the newly created the virtual graphics card. A 2D graphics buffer for storing the virtual desktop may reside in the server main memory (such as 2D buffer 556) or on the 3D graphics card with the multi-core 3D graphics accelerator (such as 2D buffer 586) where the rendering and graphics updates take place (e.g., at the sever system).

The virtual desktop rendered into the 2D graphics buffer is then communicated to the terminal system (e.g., thin-client system through the server's network card 560) where it is displayed at operation 638. Using known techniques, the content of the 2D graphics buffer may be analyzed by the software and sent over a network to the clients (e.g., terminal devices) with reduced bandwidth utilization (e.g., the lowest possible use of bandwidth for the chosen medium and the protocol). The client may maintain the representation of its 2D frame buffer, which contains a 2D representation of an actual 3D scene. Updates to the scene are reflected in the client with the maximum speed of the system. In an example embodiment, the client may be a thin-client network terminal which may or may not include a CPU. In an example embodiment, the client is designed to receive graphics data and provide the graphics data to the display without any processing.

In an example embodiment, the graphics cores that are not assigned to any session may be shut down until a new session starts. When a new session is stared, a selected core may be initialized and dedicated to that session. Thus power management functionality and/or control may be performed in example embodiments.

In another embodiment, the graphics cores that not in use may be assigned to an active session (e.g., a session with one or more cores already assigned to it). Thus, two or more graphics cores may be combined in order to further accelerate a particular session.

The graphics cores in the above described embodiments do not necessarily have to be 3D graphics cores. Furthermore 2D images and 3D images are able to be processed in similar manners.

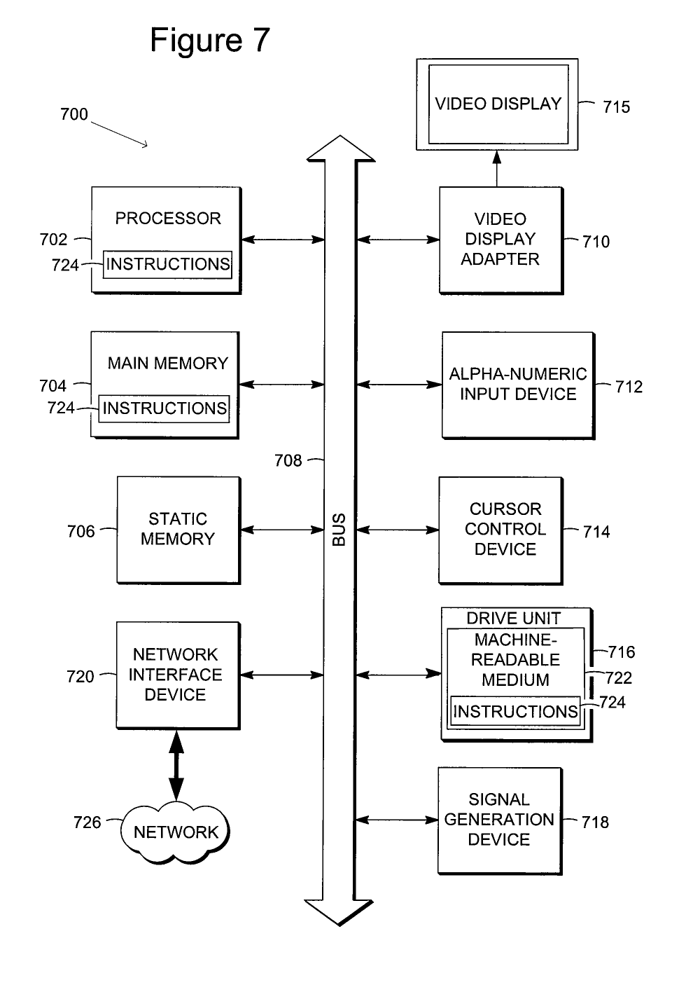

FIG. 7 illustrates a diagrammatic representation of machine in the example form of a computer system 700, in accordance with an example embodiment, within which a set of instructions 724, for causing the machine to perform any one or more of the methodologies discussed herein, may be executed. The machine may operate as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display adapter 710 that drives a video display system 715 such as a Liquid Crystal Display (LCD) or a Cathode Ray Tube (CRT). The computer system 700 also includes an alphanumeric input device 712 (e.g., a keyboard), a cursor control device 714 (e.g., a mouse or trackball), a disk drive unit 716, a signal generation device 718 (e.g., a speaker) and a network interface device 720.

In an example embodiment, a CPU is a device that controls overall operation of computer system 700. The CPU operates in multiple states and controls operations of receiving data from various input devices, processing the data, and sending the process result to an output device. The CPU includes an arithmetic logic unit (ALU) and a control unit. The ALU performs comparison, decision, and calculation operations, and the control unit decodes and executes instructions. The ALU includes: an adder for adding numbers; an accumulator for temporarily storing the result of arithmetic and logic operations; and registers. The control unit includes a program counter for controlling an execution order of programs, and an instruction register for temporarily storing a current instruction, and an instruction decoder for decoding the stored instruction to send a control signal to a corresponding device. Therefore, CPU based system 700 can perform independently based on instructions programmed in memory regardless whether or not it is connected to other computers, a network or other electronic devices.

The disk drive unit 716 includes a machine-readable medium 722 on which is stored one or more sets of computer instructions and data structures (e.g., instructions 724 also known as ‘software’) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

The instructions 724 may further be transmitted or received over a network 726 via the network interface device 720 utilizing any one of a number of well-known transfer protocols (e.g., FTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

In a personal computer system, such as the computer system 700 of FIG. 7, a video display adapter 710 drives a local video display system 715 such as a Liquid Crystal Display (LCD), a Cathode Ray Tube (CRT), or other video display device. Currently, most personal computer systems are connected with an analog Video Graphics Array (VGA) connection. Many newer personal computer systems are using digital video connections such as Digital Visual Interface (DVI) or High-Definition Multimedia Interface (HDMI). However, these types of video connections are generally used for short distances. The DVI and HDMI connections require high bandwidth connections. The video display adaptor 710 may in addition, or instead, drive a remote display connected to one or more network terminals connected via a network (e.g., a local area network (LAN) or wide area network (WAN)).

In an example situation where the graphics adaptor 710 interfaces with a plurality of networked terminal devices which are thin-clients (e.g., the clients may or may not include a CPU), the amount of bandwidth required for transmitting a video signal may be reduced. For example, over-the-air terrestrial, satellite, and cable digital video broadcasts desire reduced bandwidth video in order to transmit as many channels of video as possible.

The preceding description is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated.

What is claimed is:

1. A system for rendering graphics to be displayed remotely, the system comprising:
a processor to create a virtual machine session and a virtual graphics card associated with the virtual machine session; and
a graphics core of a plurality of graphics cores to be assigned a virtual graphics card and to render a virtual desktop on the virtual graphics card for remote display.

2. The system of claim 1 wherein the plurality of graphics cores is provided on the same silicon die.

3. The system of claim 2 wherein the silicon die is a graphics card.

4. The system of claim 1 wherein each graphics core is not shared with another virtual machine session.

5. The system of claim 1 wherein two or more graphics cores are combined to serve a particular session.

6. The system of claim 1 wherein graphics cores not assigned a virtual graphics card are shut down until assigned a virtual graphics card.

7. The system of claim 1 wherein each virtual machine session has an associated buffer.

8. The system of claim 7 wherein the associated buffer is on a graphics card.

9. A method of rendering graphics, the method comprising:
creating a virtual machine session;
creating a virtual graphics card associated with the virtual machine session;
assigning the virtual graphics card to at least one physical graphics core of a plurality of physical graphics cores on a machine; and
rendering a virtual desktop on the virtual graphics card for display remotely.

10. The method of claim 9 wherein the plurality of graphics cores is provided on the same silicon die.

11. The method of claim 10 wherein the silicon die is a graphics card.

12. The method of claim 9 wherein each graphics core is not shared with another virtual machine session.

13. The method of claim 9 wherein two or more graphics cores are combined to serve a particular session.

14. The method of claim 9 wherein graphics cores not assigned a virtual graphics card are shut down until assigned a virtual graphics card.

15. The method of claim 9 wherein each virtual machine session has an associated buffer.

16. The method of claim 15 wherein the associated buffer is on a graphics card.

17. A system comprising:
a first means for creating a virtual machine session at a server and creating a virtual graphics card for the virtual machine session; and
a second means for rendering a virtual desktop on the virtual graphics card for remote display.

18. A machine-readable medium embodying a series of instructions that, when executed by a machine, cause the machine to perform the steps of:
creating a virtual machine session at a server;
creating a virtual graphics card for the virtual machine session;
assigning the virtual graphics card to at least one physical graphics core of a plurality of physical graphics cores on a machine; and
rendering a virtual desktop on the virtual graphics card for display remotely.
